(19) United States
(12) Patent Application Publication
(10) Pub. No.: US 2021/0073822 A1
(43) Pub. Date: Mar. 11, 2021

(54) DATA TRANSMISSION VIA DUAL CHANNELS

(71) Applicant: Stripe, Inc., San Francisco, CA (US)

(72) Inventors: Michael David Dahn, San Francisco, CA (US); Bryan Daniel Berg, Seattle, WA (US)

(21) Appl. No.: 17/088,873

(22) Filed: Nov. 4, 2020

Related U.S. Application Data
(63) Continuation of application No. 15/789,641, filed on Oct. 20, 2017.

(51) Int. Cl. G06Q 20/40; G06Q 20/38

(52) U.S. Cl. CPC G06Q 20/4018; G06F 3/04817; G06Q 20/385

(57) ABSTRACT

A method enables the transmission of encrypted and unencrypted data over different channels. The method includes: receiving, at a first device, unencrypted data via a first channel; causing, by the first device, generating a data entry form at a second device based on the received unencrypted data; causing, by the first device, transmitting, from the second device, the generated data entry form to a third device via a second channel, the generated data entry to be displayed within a webpage on the third device; causing, by the first device, intercepting and encrypting data entered into the generated data entry from by a user; and receiving, by the first device, via the second channel the encrypted data.

### CROSS REFERENCE TO RELATED APPLICATION

This application is a continuation of U.S. patent application Ser. No. 15/789,641 filed Oct. 20, 2017, which is hereby incorporated by reference.

### TECHNICAL FIELD

The subject matter disclosed herein generally relates to the technical field of transmitting encrypted and unencrypted data over different channels.

### BACKGROUND

The present disclosure seeks to address technical problems existing in conventional payment processors and call centers. For example, many merchants have call centers or otherwise have the need to be able to accept regulated data (e.g., payment information) via telephone. In the payments context, existing solutions create tremendous burdens on the call center because receiving sensitive payment card information (e.g., more than just the first 6 or last 4 of the PAN, Card Verification Value or Code) in such a manner can cause the entire call center to fall within scope for the Payment Card Industry (PCI) requirements requiring, among other requirements, special encryption protocols.

One option for merchants is to properly segment one or a limited number of computers from the rest of the computer network such that those computers alone can receive or input such information. This approach is still fraught with challenges, however, and failure to properly implement such a segmentation can result in the entire call center (and in some cases, the entire company) falling within PCI scope. These problems can be complicated because the merchant's customers might not have ready access to a computer or smartphone, or otherwise be comfortable with online payment options.

There thus exists a need for technical solutions to the problem of how a call center can receive card data in a secure and convenient manner, without causing the entire call center to fall within PCI scope.

### BRIEF DESCRIPTION OF THE DRAWINGS

Some embodiments are illustrated by way of example and not limitation in the figures of the accompanying drawings. In order to identify more easily the discussion of any particular element or act, the most significant digit or digits in a reference number refer to the figure number in which that element is first introduced.

FIG. 1 is a block diagram illustrating a networked system, according to an example embodiment.

FIG. 2 is a block diagram showing architectural aspects of a networked system, according to some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 is a block diagram showing aspects of an online method for conducting a transaction between a merchant site and an electronic user device using a payment processor, according to an example embodiment.

FIG. 6 (prior art) is a block diagram showing a PCI/non-PCI partitioning arrangement in a conventional call center, according to an example embodiment.

FIGS. 7-8 show tables listing aspects of the present disclosure, according to some embodiments.

FIG. 9 is a flowchart for a method for conducting a transaction between a merchant site and an electronic user device using a payment processor, according to an example embodiment.

### DETAILED DESCRIPTION

“Carrier Signal” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“Client Device” or “Electronic Device” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may use to access a network.

“Customer's Electronic Device” or “Electronic User Device” in this context refers to a client device that the customer uses to interact with the merchant. Examples of this device include a desktop computer, a laptop computer, a mobile device (e.g., smartphone, tablet) and game console. The customer's electronic device may interact with the merchant via a browser application that executes on the device, or via a native app installed onto the customer's device. The client-side application executes on the customer's electronic device.

“Communications Network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“Component” in this context refers to a device, physical entity, or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Machine-Readable Medium” in this context refers to a component, device or other tangible media able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” in one context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

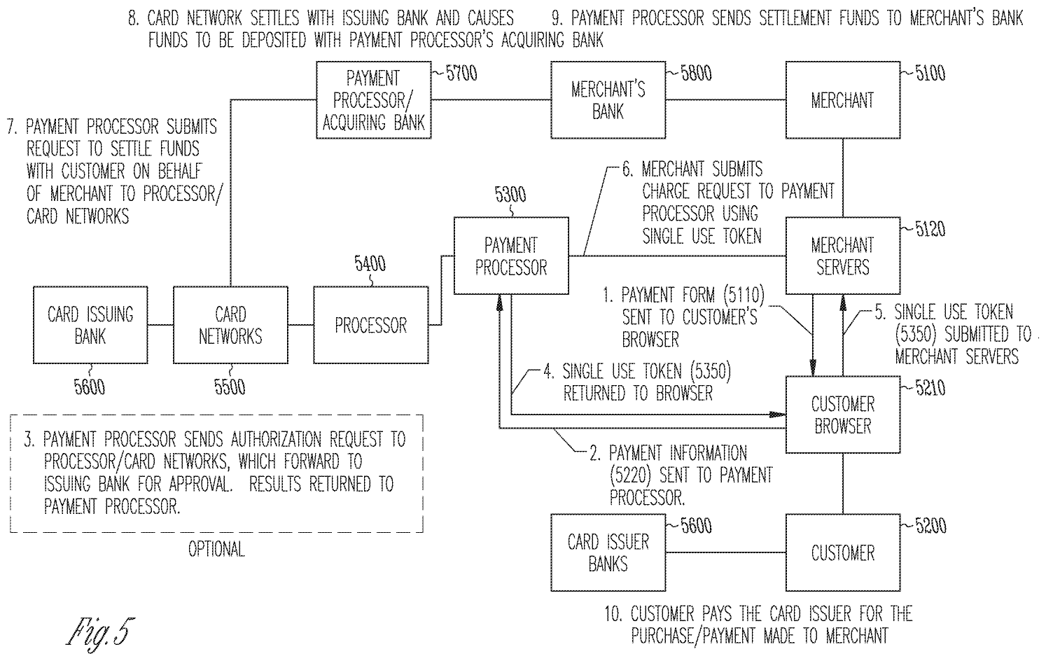

In another context, a “Processor”, also referred to herein as “processor (5400 in FIG. 5),” is a company (often a third party) appointed to handle payment card transactions (e.g., credit card, debit card). They have connections to various card networks and supply authorization and settlement services to merchants or payment service providers. In aspects, they can also move the money from an issuing bank to a merchant or acquiring bank.

“Card Network” (or “Card Association”) in this context refers to financial payment networks such as Visa®, MasterCard®, American Express®, Diners Club®, JCB® and China Union-Pay®.

“Acquiring Bank” or “Acquirer” in this context refers to a bank or financial institution that accepts credit and/or debit card payments from affiliated card networks for products or services on behalf of a merchant or payment service provider.

“Card Issuing Bank” in this context refers to a bank that offers card network or association branded payment cards directly to consumers. An issuing bank assumes primary liability for the consumer's capacity to pay off debts they incur with their card.

“Payment Information” includes information required to complete a transaction, and the specific type of information provided may vary by payment type. Some payment information will be sensitive (e.g., the card validation code) while other information might not be (e.g., zip code). For example, when making payment via a credit card or debit card, the payment information includes primary account number (PAN) or credit card number, card validation code, expiration month, and year. In another payment example, for instance made using an Automated Clearinghouse (ACH) transaction, the payment information includes a bank routing number and an account number within that bank.

“Sensitive information” may not necessarily be related to payment information and may include other confidential personal information, such as medical (HIPAA) information, for example. The ambit of the term “Payment Information” includes “Sensitive Information” within its scope. In some examples, sensitive payment information may include “regulated payment information”, which may change over time. For example, currently a merchant cannot collect more than the first six (6) or the last four (4) numbers of a customer's PAN without generally needing to comply with PCI regulations. But card lengths may change, and when they do the “6 and 4” rules will likely change with them. These potential future changes are incorporated within the ambit of “regulated payment information” which is in turn included within the ambit of the term “payment information” as defined herein.

“Merchant” in this context refers to an entity that is associated with selling or licensing products and/or services over electronic systems such as the Internet and other computer networks. The merchant may be the direct seller/licensor, or the merchant may be an agent for a direct seller/licensor. For example, entities such as Amazon® sometimes act as the direct seller/licensor, and sometimes act as an agent for a direct seller/licensor.

“Merchant Site” in this context refers to an e-commerce site or portal (e.g., website, or mobile app) of the merchant. The merchant (100) and merchant server (120) in some figures are associated with the merchant site. The merchant site is associated with a client-side (client side) application and a server-side (server side) application. In one example embodiment, the merchant site includes the Merchant Server (120 in FIG. 5), and the server-side application executes on the Merchant Server (120).

“Payment Processor” in this context (e.g. Payment Processor, 5300 in FIG. 5) refers to an entity or a plurality of entities that facilitate a transaction between a merchant site and a customer's electronic device. With reference to a high-level description illustrated in FIG. 5, in some examples described more fully below, the payment processor includes selected functionality of both Stripe (5300) and Processor (5400)/Card Networks (5500). For example, Stripe (5300) creates tokens and maintains and verifies publishable (non-secret) keys and secret keys. In the illustrated example, the Processor (5400)/Card Networks (5500) is involved in authorizing or validating payment information. In one example embodiment, Stripe (5300) and the Processor (5400)/Card Networks (5500) function together to authorize and validate payment information, issue a token, and settle any charges that are made. Accordingly, in this embodiment, the payment processor refers to the functionality of Stripe (5300) and the functionality of the Processor (5400)/Card Networks (5500). In another example embodiment wherein step (3) in the high-level description is not performed, and Stripe (5300) performs its own verification before issuing a token, the Processor (5400)/Card Networks (5500) are still used for settling any charges that are made, as described in step (7) in the high-level description. Accordingly, in this embodiment, the payment processor may refer only to the functionality of Stripe (50) with respect to issuing tokens. Further, in the example arrangement shown, Payment Processor (5300), Processor (5400), and the Card Networks (5500) are shown as separate entities. In some examples, their respective functions may be performed by two entities, or even just one entity, with the entities themselves being configured accordingly.

“Native Application” or “native app” in this context refers to an app commonly used with a mobile device, such as a smartphone or tablet. When used with a mobile device, the native app is installed directly onto the mobile device. Mobile device users typically obtain these apps through an online store or marketplace, such as an app store (e.g., Apple's App Store, Google Play store). More generically, a native application is designed to run in the computer environment (machine language and operating system) that it is being run in. It can be referred to as a locally installed application. A native application differs from an interpreted application, such as a Java applet, which requires interpreter software. A native application also differs from an emulated application that is written for a different platform and converted in real time to run, and also differs from a Web application that is run within the browser.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings form a part of this document: Copyright 2011-2017, Stripe, Inc., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

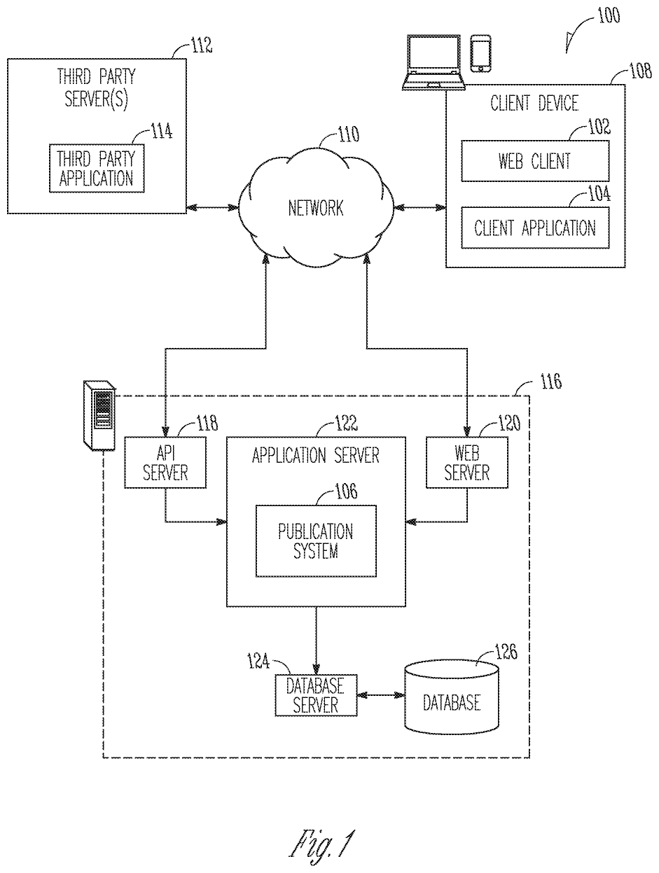

With reference to FIG. 1, an example embodiment of a high-level SaaS network architecture 100 is shown. A networked system 116 provides server-side functionality via a network 110 (e.g., the Internet or wide area network (WAN)) to a client device 108. A web client 102 and a programmatic client, in the example form of a client application 104, are hosted and execute on the client device 108. The networked system 116 includes an application server 122, which in turn hosts a publication system 106 (such as the publication system hosted at https://stripe.com by Stripe, Inc. of San Francisco, Calif. (herein “Stripe”, as an example of a payment processor)) that provides a number of functions and services to the application 104 that accesses the networked system 116. The application 104 also provides a number of interfaces described herein, which present output of the scheduling operations to a user of the client device 108.

The client device 108 enables a user to access and interact with the networked system 116, and ultimately the publication system 106. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled, and provide programmatic and web interfaces respectively, to the application server 122. The application server 122 hosts the publication system 106, which includes components or applications described further below. The application server 122 is, in turn, shown to be coupled to a database server 124 that facilitates access to information storage repositories (e.g., a database 126). In an example embodiment, the database 126 includes storage devices that store information accessed and generated by the publication system 106.

Additionally, a third-party application 114, executing on a third-party server(s) 112, is shown as having programmatic access to the networked system 116 via the programmatic interface provided by the Application Program Interface (API) server 118. For example, the third-party application 114, using information retrieved from the networked system 116, may support one or more features or functions on a website hosted by the third party.

Turning now specifically to the applications hosted by the client device 108, the web client 102 may access the various systems (e.g., publication system 106) via the web interface supported by the web server 120. Similarly, the application 104 (e.g., an “app” such as a Stripe, Inc. app) accesses the various services and functions provided by the publication system 106 via the programmatic interface provided by the Application Program Interface (API) server 118. The application 104 may be, for example, an “app” executing on a client device 108, such as an iOS or Android OS application to enable a user to access and input data on the networked system 116 in an off-line manner, and to perform batch-mode communications between the programmatic client application 104 and the networked system networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The publication system 106 could also be implemented as a standalone software program, which does not necessarily have networking capabilities.

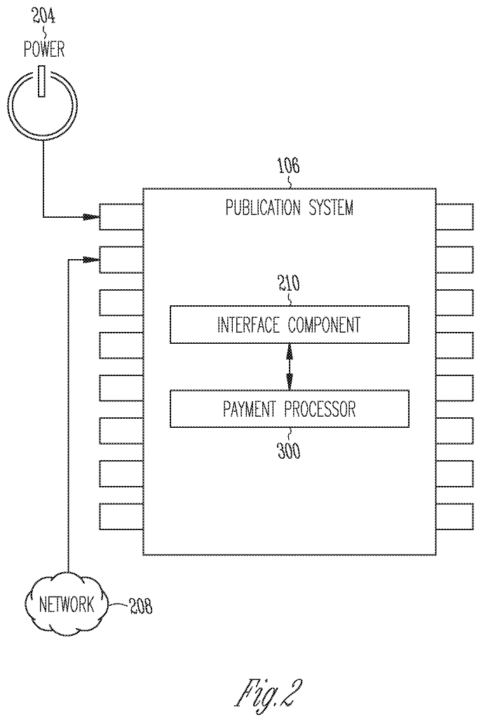

FIG. 2 is a block diagram showing architectural details of a publication system 106, according to some example embodiments. Specifically, the publication system 106 is shown to include an interface component 210 by which the publication system 106 communicates (e.g., over the network 208) with other systems within the SaaS network architecture 100.

The interface component 210 is communicatively coupled to a payment processor 300 that operates to provide call center payment functionality in accordance with the methods described herein with reference to the accompanying drawings.

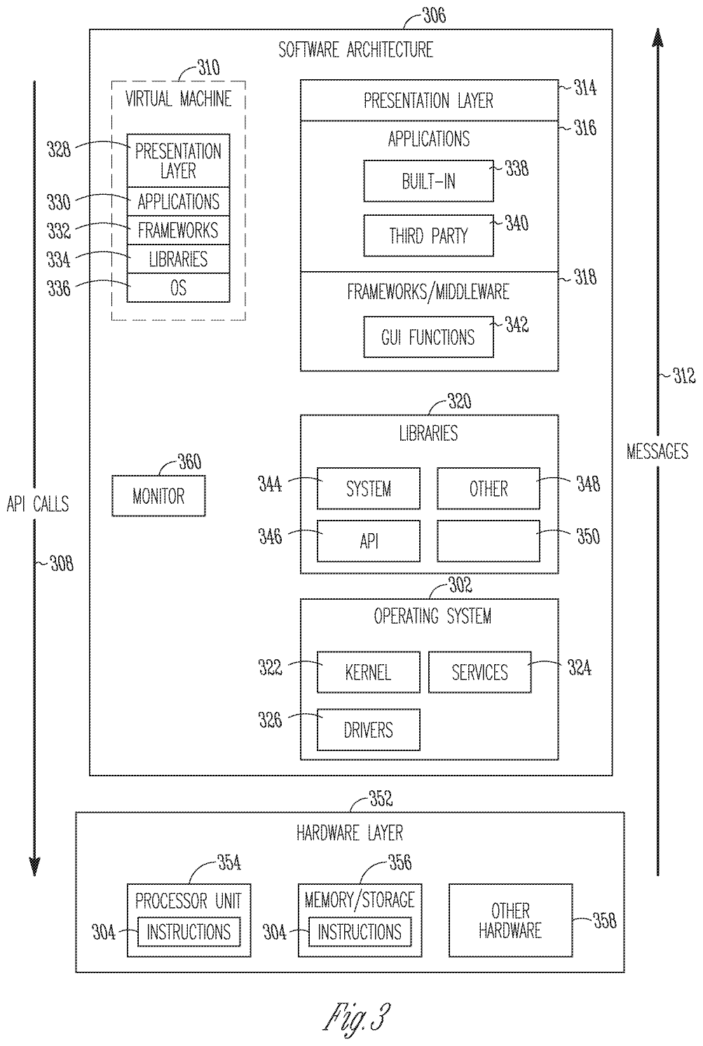

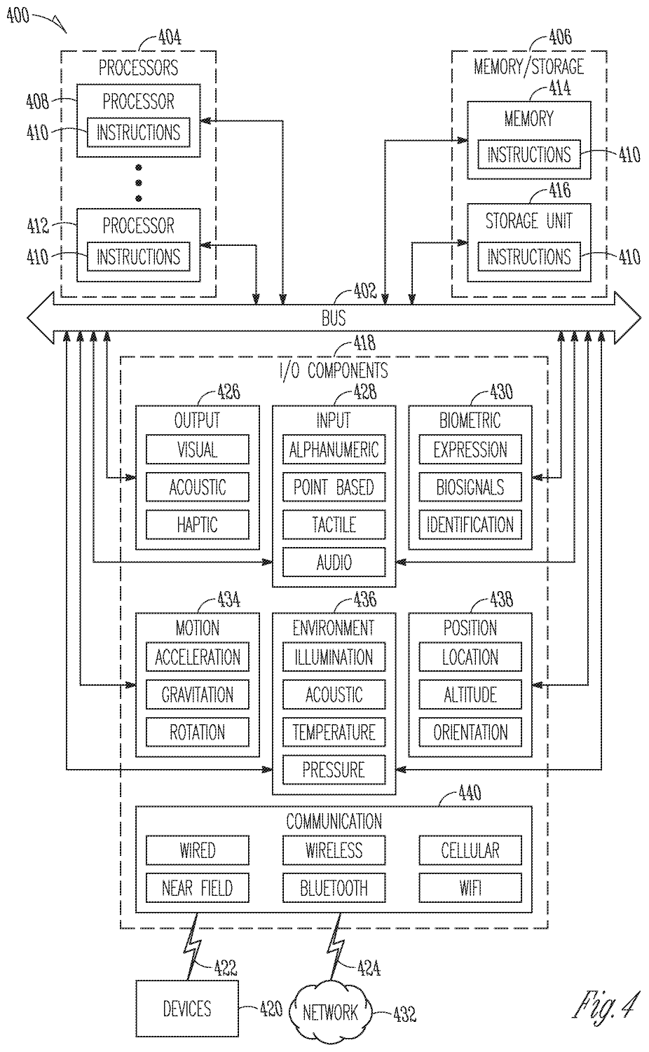

FIG. 3 is a block diagram illustrating an example software architecture 306, which may be used in conjunction with various hardware architectures herein described. FIG. 3 is a non-limiting example of a software architecture 306 and it will be appreciated that many other architectures may be implemented to facilitate the functionality described herein. The software architecture 306 may execute on hardware such as machine 400 of FIG. 4 that includes, among other things, processors 404, memory/storage 406, and I/O components 418. A representative hardware layer 352 is illustrated and can represent, for example, the machine 400 of FIG. 4. The representative hardware layer 352 includes a processing unit 354 having associated executable instructions 304. Executable instructions 304 represent the executable instructions of the software architecture 306, including implementation of the methods, components and so forth described herein. The hardware layer 352 also includes memory and/or storage modules as memory/storage 356, which also have executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, applications 316 and a presentation layer 314. Operationally, the applications 316 and/or other components within the layers may invoke application programming interface (API) API calls 308 through the software stack and receive a response as messages 312 in response to the API calls 308. The layers illustrated are representative in nature and not all software architectures have all layers. For example, some mobile or special purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than to interface directly with the underlying operating system 302 functionality (e.g., kernel 322, services 324 and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 (also sometimes referred to as middleware) provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. Third-party applications 340 may include any application developed using the ANDROID™ or IOS™ software development kit (SDK) by an entity other than the vendor of the particular platform, and may be mobile software running on a mobile operating system such as IOS™, ANDROID™ WINDOWS® Phone, or other mobile operating systems. The third-party applications 340 may invoke the API calls 308 provided by the mobile operating system (such as operating system 302) to facilitate functionality described herein.

The applications 316 may use built-in operating system functions (e.g., kernel 322, services 324 and/or drivers 326), libraries 320, and frameworks/middleware 318 to create user interfaces to interact with users of the system. Alternatively, or additionally, in some systems, interactions with a user may occur through a presentation layer, such as presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (operating system (OS) 336 in FIG. 3) and typically, although not always, has a virtual machine monitor 360, which manages the operation of the virtual machine 310 as well as the interface with the host operating system (i.e., operating system 302). A software architecture executes within the virtual machine 310 such as an operating system (OS) 336, libraries 334, frameworks 332, applications 330 and/or presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine into a particular machine programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404, memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion and the grouping is in no way limiting. In various example embodiments, the I/O components 418 may include output components 426 and input components 428. The output components 426 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438 among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 438 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via coupling 424 and coupling 422, respectively. For example, the communication components 440 may include a network interface component or other suitable device to interface with the network 432. In further examples, communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a Universal Serial Bus (USB)).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting a NFC beacon signal that may indicate a particular location, and so forth.

In some embodiments, a JavaScript library (such as Stripe.js) can be wired into a merchant's checkout form to handle credit card information. When a user attempts to complete a transaction using the checkout form, it sends the credit card information directly from the user's browser to Stripe's servers. Stripe.js provides merchants with a set of technologies that can be easily and quickly integrated to securely accept payments online. With Stripe.js, merchants retain full control of their customers' payment flows, but their servers are never exposed to sensitive payment information.

When added to a merchant's payment form, Stripe.js automatically intercepts the payment form submission, sending payment information directly to Stripe and converting it to a Single-use Token. The Single-use Token can be safely passed to the merchant's systems and used later to charge customers. Merchants have complete control of their customers' payment experience without ever handling, processing, or storing sensitive payment information.

Viewed broadly in one example, and with reference to FIG. 5, Stripe.js works as follows:

1. The Merchant's Customer (5200) uses an internet-enabled browser (5210) to visit the Merchant's site. Customer is served a Stripe.js enabled Payment Form (5110) using standard web technologies. The Customer (5200) enters the specified information including their Payment Information (5220) and submits the Payment Form (5110). The Billing Info portion of the Payment Form (5110) is for payment via a credit card or debit card. If payment is to be made via an Automated Clearinghouse (ACH) transaction, the Billing Info portion of the Payment Form (5110) will request a bank routing number and an account number within that bank, and possibly additional information, such as the bank name and whether the account is a checking or savings account.

2. The Customer's payment information (5220) is sent from the Customer's browser (5210) to Stripe (5300), never touching the Merchant's Servers (5120). In this manner, the client-side application electronically sends payment information retrieved from the customer's electronic device to the payment processor. The client-side application does not send the payment information (5220) to the server-side application.

3. In one preferred embodiment, Stripe (5300) submits the relevant transaction to a Processor (5400) or directly to the Card Network (5500) for authorization or validation of the payment information. The Card Network (5500) sends the request to the Card Issuing Bank (5600), which authorizes the transaction. In this embodiment, Stripe (5300) and Processor (5400)/Card Network (5500) function together as a payment processor. In another example embodiment, this step is performed without any communication to the Processor (5400)/Card Network (5500). Instead, Stripe (5300) performs its own authorization or validation of the payment information using heuristic means, such as by checking the Bank Identification Number (BIN), also referred to as the Issuer Identification Number (IIN), against a database of known, valid BINS that is on file with Stripe (5300). (The BIN is a part of the bank card number, namely the first six digits.) In yet another example embodiment, this step is not performed at all since the authorization or validation is not necessary for the next step (4) to succeed. That is, it is acceptable to create a Single-use Token in step (4) that represents payment information which has not been validated in any way.

4. If authorized, Stripe (5300) will generate and return a secure, Single-use Token (5350) to the Customer's Browser (5210) that represents the customer's payment information (220) but doesn't leak any sensitive information. In the example embodiment wherein step (3) is not performed, Stripe (5300) performs this step without waiting to receive authorization from the Processor (5400) or the Card Network (5500). In this manner, the payment processor (here, Stripe (5300)) creates the Token (5350) from the payment information sent by the client-side application, wherein the Token (5350) functions as a proxy for the payment information (5220).

5. The Payment Form (5110) is submitted to Merchant Servers (5120), including the Single-use Token (5350). More specifically, the payment processor sends the Token (5350) to the client-side application, which, in turn, sends the Token (5350) to the server-side application for use by the server-side application in conducting the transaction.

6. The Merchant (5100) uses the Single-use Token (5350) to submit a charge request to Stripe (5300) (or to create a Customer object for later use). In this step, Stripe (5300) submits a request to authorize the charge to the Processor (5400) or directly to the Card Network (5500). This authorization specifies the actual amount to charge the credit card. If an authorization was already done in step (3) for the correct amount, this authorization request can be skipped. This may be a one-time payment for a merchant item, or it may involve registering the payment information with the merchant site for subsequent use in making a payment for a merchant item (so-called “card on file” scenario). Using the process described in steps (1) through (6), the payment information can be used by the server-side application via the Token (5350) without the server-side application being exposed to the payment information.

7. Stripe (5300) settles the charge on behalf of the Merchant (5100) with the Processor (5400) or directly with the Card Network (5500).

8. The Card Network (5500) causes the funds to be paid by the Card Issuing Bank (5600) to Stripe (5300) or to Stripe's Acquiring Bank (5700).

9. Stripe (5300) causes the settled funds to be sent to the Merchant (100) (or to the Merchant's Bank (5800)), net of any applicable fees.

10. The Card Issuing Bank (5600) collects the paid funds from the Customer (5200).

Not all of the steps listed above need happen in real time. Other examples, arrangements and functionality are possible. Applicant's published patent application US 2013/0117185 A1 is incorporated by reference in its entirety in this regard. Typically, when the Merchant's Customer submits the payment form in step (1), steps (1) through (6) happen in real time and steps (7) through (10) happen later, usually once per day, as a batch process settling all of the funds for all of Stripe's merchants. In some examples, the payment processor uses an http-based tokenization API for use in steps (2) and (4) above. Some broader examples may be considered as “tokenization as a service” in which any data is tokenized. One general example may facilitate a merger and acquisition (M&A) analysis in which companies want to compare an overlap in their customer base with another. A payment processor (acting as a tokenization service) can tokenize the customers of each company and compare the overlap without revealing confidential information to either party. Unique payment tokens can be adapted to enable and facilitate such a tokenization service.

As mentioned above, the present disclosure seeks to address technical problems existing in conventional payment processors and call centers. For example, many merchants have call centers or otherwise have the need to be able to accept regulated data (e.g., payments information) via telephone. In the payments context, existing solutions create tremendous burdens on the call center because receiving card information (e.g., more than just the first 6 or last 4 of the PAN, Card Verification Value or Code) in such a manner can cause the entire call center to fall within scope for the Payment Card Industry (PCI) requirements, requiring special encryption protocols.

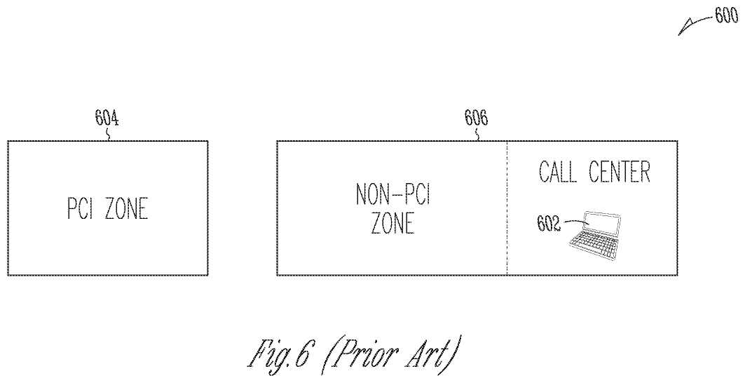

With reference to FIG. 6 (prior art), one conventional option for merchants is to properly segment one or a limited number of computers from the rest of the computer network such that those computers alone can receive or input such information. FIG. 6 illustrates a partitioning arrangement 600 for a call center 602. The call center 602 is divided into a PCI zone 604, which is PCI compliant and adheres to the relevant PCI protocols. A non-PCI zone 606 is kept separate from the PCI zone 604. A call center 602 agent dealing with a customer transaction in the non-PCI zone 606 would inconveniently have to redirect the customer to an agent in the PCI zone 604 as soon as regulated information became involved in the transaction. This partitioning approach is still fraught with challenges, however, and failure to properly implement such a segmentation can result in the entire call center 602 (and in some cases the entire company) falling within PCI scope. These problems can be complicated because the merchant's customers might not have ready access to a computer or smartphone, or otherwise be comfortable with online payment options.

There thus exists a need for technical solutions to the problem of how a call center can receive card data in a secure and convenient manner, without causing the entire call center to fall within PCI scope.

In some embodiments, these problems are addressed through a system in which a call center agent can dynamically generate a unique data entry form for the customer through which the customer can enter his or her information required to complete a transaction. The agent may be a human, a machine such as “bot,” or online digital assistant trained on or supported by artificial intelligence. The call center may belong to or be associated with a merchant. The unique data entry form itself can be hosted on a merchant's site (or within an application), or by a payment processor such as Stripe.

In some embodiments, the form is a web- or mobile-based form. While on a call with a customer, a call center agent's system can dynamically create the unique data entry form. The form can be provided to the customer by any convenient means, for example, by a text, an email link, a pop-up, or other in-line integration which, when activated, brings the customer to the web or mobile based form to complete the information.

In some embodiments, the call center agent may ask for a set of information that can be received via telephone without triggering PCI obligations, such as regulated information including the first 6 or last 4 of the PAN. The form that is sent to the user permits only the entry of the remaining information, thus giving the customer increased confidence that the form to which they enter information is legitimate because it already contains the information known to the call center agent.

In some embodiments, before generating the form, the call center agent may ask for additional, non-regulated information from the customer to place the customer more at ease in entering regulated payment information. For example, the agent could ask for a specific word or picture that the customer would like displayed on the form, such that the resulting payment form contains that word or picture as an additional measure of security for the end user. In some examples, the image is a one-time, or ephemeral, image that can only be used for authorization in one instance, and then is no longer effective for that purpose. A new image may be required for subsequent authorization requests.

As mentioned above, such forms can be housed from a payment processor such as Stripe. The call center agent's system can initiate a request to create a payment page, which will create a unique checkout or payment entry form (such as Stripe Elements form) and a unique URL. A merchant's ID and a transaction ID can be furnished to the payment processor so that the payment information entered via the checkout or payment form can be tied back to the associated transaction appropriately. The merchant can optionally also furnish the amount and/or the PAN information described above so that the checkout form can be prepopulated with this information. In certain aspects, the form may be usable only one time, or time out after a certain amount of time (for example, after 30 minutes, or 60 minutes, and so forth). In certain embodiments, the form is served up via a cardholder app.

Thus, in some example use cases of the present methods, service providers can accept many different types of regulated data. In one example, a medical provider (for example, a doctor or wellness center) can conveniently enable a user (for example, a patient) to enter blood glucose level information on a regular basis (for example, daily) using an app or online method described herein, as opposed to requiring the patient to call or walk in and notify their doctor. In another example, a patient can use the methods described herein to send blood lab results to a hospital. Thus, as indicated further above, the term “payment information” in the present context can include within its scope not just PCI information but also other confidential information, for example that which could fall under HIPAA requirements. For example, in a medical use case, a provider such as OneMedical uses a unique data entry form within their app to collect data from their customers.

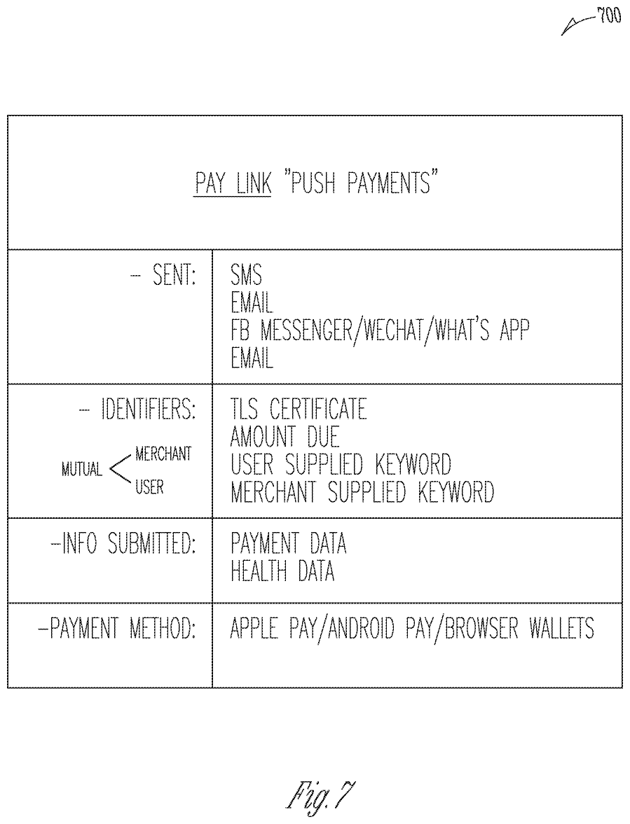

Other aspects of the inventive subject matter are shown in FIG. 7 which illustrates a Table 700 of certain design aspects of a “pay link” described herein. The pay link may form, or be associated with, the data entry element described herein. For example, the pay link may be embedded in an electronic form or independently sent to a customer by a network such as an SMS network, email, Facebook (FB) Messenger, WeChat, WhatsApp, or iMessage.

Pay link identifiers for authorization or other purposes may independently, or in conjunction with an electronic data entry form, include one or more of a Transport Security Layer (TLS), a specific amount due, a user supplied keyword (such as a word, term, picture, or icon), or a merchant supplied keyword (such as a word, term, picture, or icon), or a combination of the two. A keyword may be identified by agreement between two or more of a merchant, a call center agent, and a customer. The information submitted in a pay link may include regulated (or non-regulated) payment information, as well as personal identification data, or other confidential information such as health data.

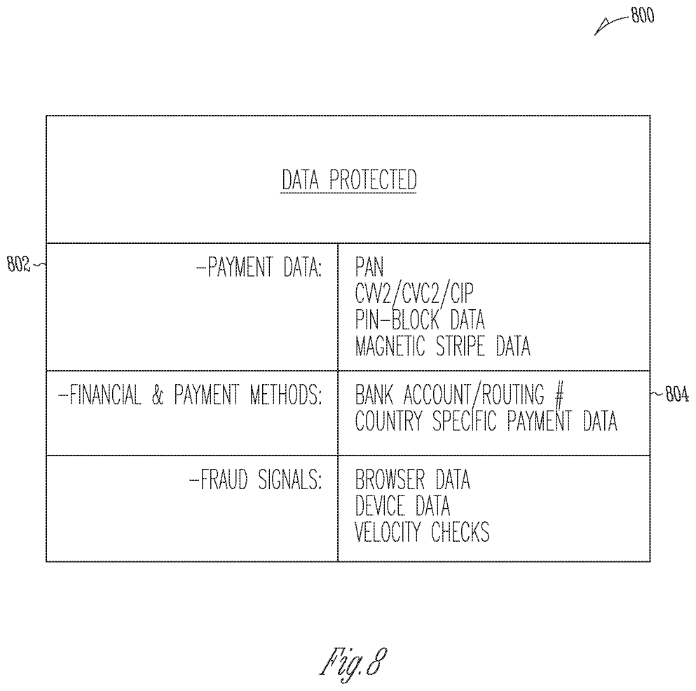

In some examples, the pay link is designed to redirect any received regulated data to a PCI-compliant processing center, such a payment processor, for example Stripe. Other processors, such as health-related processors, are possible. The processing center may tokenize the regulated information for use in a PCI-compliant manner in other applications by other parties, for example as a representation of funds owed to a merchant by a customer pursuant to completion of a transaction. Thus, with reference to FIG. 8, Table 800 displays example types of regulated data that can be protected by the present methods including, at 802, payment data, such as a PAN, CVV2/CVC2/CID data, a PIN or block data, and magnetic stripe data. Protected financial and payment methods may include, at 804, bank account and routing numbers, and country-specific payment data. Fraud signals requiring security protection can be protected and transmitted securely in a PCI-compliant manner. These signals can include for example browser data, device data, transaction velocity checks, and other patterns of behavior.

In some examples, an existing data entry or payment form can be converted for performing the methods of the present disclosure. A data entry element can be made available as part of a script (for example, as available at stripe.js). Within the script, a sub-routine can create UI components and insert them into the data entry form. Using these and further aspects within the script, a call center (or merchant) can build and configure specific input fields, validation, and formatting when creating their data entry forms. These components securely collect card information from customers. When a data entry form is completed during a call center session, the regulated PCI information entered into the data entry element is passed directly to a payment (or other) processor, such as Stripe. In some examples, a token is returned by the processor to the call center (or merchant) that can then be used by the call center (or merchant) to make a charge request or to save the regulated information for later, or for other purposes.

In running the script to implement the present methods, a call center can create data entry elements for a data entry form by creating empty DOM elements (containers) instead of directly using DOM <input>s. The script, or an aspect of it, inserts a processor-hosted UI component within the container(s). In some examples, migrating to this arrangement triggers other aspects of the script such as a card element. This flexible UI component simplifies a data entry form by minimizing the number of fields needed, and may need much less markup.

```
  A portion of an example script appears below:
  <form action=“/charge” method=“post” id=“payment-form”>
  <div class=“form-row”>
```

<label for=“card-element”>

Credit or debit card

</label>
<div id=“card-element”>

<!-- a Stripe Element will be inserted here. -->

</div>
<!-- Used to display form errors -->
<div id=“card-errors” role=“alert”></div>

```
  </div>
  <input type=“submit” class=“submit” value=“Submit Payment”>
</form>
```

Next, a processor (Stripe) client is initialized by the call center (or merchant) providing a publishable API key, then creating an instance of the data entry element in the data entry form. A further portion of a sample script appears below:

var stripe=Stripe(‘pk_test_6pRNASCoBOKtIshFeQd4XMUh’);

var elements=stripe.elements( );

The call center (or merchant) can now create a card element and add it to the data entry form using a mount( ) method. For example:

var card = elements.create(′card′);
// Add an instance of the card UI component into the ‘ card-element‘
<div>
card.mount(′#card-element′);

In some examples, a call center may cause the PCI-regulated information of its customers to be redirected to an external payment (or other) processor for tokenization. This functionality can be built into a data entry form using a sample script as follows:

function stripeTokenHandler(token) {
// Insert the token ID into the form so it gets submitted to the server
var form = document.getElementById(‘payment-form’);
var hiddenInput = document.createElement(‘input’);
hiddenInput.setAttribute(‘type’, ‘hidden’);
hiddenInput.setAttribute(‘name’, ‘stripeToken’);
hiddenInput.setAttribute(‘value’, token.id);
form.appeudChild(hiddenInput);
// Submit the form
form.submit( );
}
function createToken( ) {
stripe.createToken(card).then(function(result) {
if (result.error) {
// Inform the user if there was an error
var errorElement = document.getElementById(‘card-errors’);
errorElement.textContent = result.error.message;
} else {
// Send the token to your server
stripeTokenHandler(result.token);
}
});
};
// Create a token when the form is submitted.
var form = document.getElementById(‘payment-form’);
form.addEventListener(‘submit’, function(e) {
e.preventDefault( );
createToken( );
});

Thus, in some embodiments, there is provided a networked call center system for conducting a transaction with a customer user, the transaction involving the submission by the customer user of information which includes regulated payment information, the networked call center system comprising: a network; processors; and a memory storing instructions that, when executed by at least one processor among the processors, cause the networked call center system to perform operations comprising, at least: receiving a voice call from the customer user and establishing a verbal line of communication with the customer user in a user session; creating an electronic data entry form, embedding a data entry element in the form for receiving the regulated payment information, and linking the data entry element to a payment instrument or a payment processor; during the session, serving the electronic data entry form to the customer user over a network; and receiving non-regulated verbal information from the customer user via the verbal line of communication, and the regulated payment information via the data entry form and the network. The operations may further comprise one or more of the steps described further below.

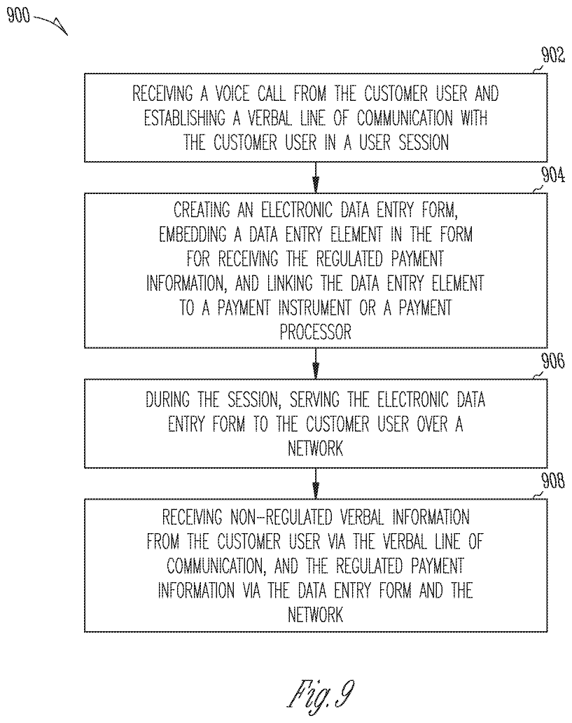

With reference to FIG. 9, some embodiments of the present inventive subject matter include methods 900 for conducting, at a networked call center, a transaction with a customer user, the transaction involving the submission by the customer user of information which includes regulated payment information, the method comprising, at least: at operation 902, receiving a voice call from the customer user and establishing a verbal line of communication with the customer user in a user session; at operation 904, creating an electronic data entry form, embedding a data entry element in the form for receiving the regulated payment information, and linking the data entry element to a payment instrument or a payment processor; at operation 906, during the session, serving the electronic data entry form to the customer user over a network; and, at operation 908, receiving non-regulated verbal information from the customer user via the verbal line of communication, and the regulated payment information via the data entry form and the network.

In some examples, the method 900 may further comprise, during the session: verbally requesting from the customer user the non-regulated information including at least a portion of a user PAN; in response to the request, receiving verbally from the customer user the non-regulated information including at least the portion of the user PAN; and requesting or prompting the user to enter the regulated payment information comprising at least the balance of the user PAN into the data entry element of the data entry form.

In some examples, the networked call center is associated with a merchant, and the method 900 may further comprise: directing the entered regulated payment information to a payment processor without triggering, at the networked call center or the merchant, compliance obligations under payment information regulations.

In some examples, the method 900 may further comprise: directing the regulated payment information to the payment processor for tokenization by the payment processor and receipt by the merchant of a token representing a payment instrument associated with the transaction.

In some examples, the method 900 may further comprise: during the session, verbally requesting from the customer user a user-specified authentication term or icon; embedding the user-specified authentication term or icon into the data entry form before it is served to the customer user; and during the session, causing the display, to the customer user, of the user-specified authentication term or icon in the data entry form.

In some examples, the method 900 may further comprise: providing a link to the electronic data entry form or the data entry element in an app; and receiving, via the app, the regulated payment information, or redirecting the regulated payment information to a payment processor.

Some embodiments include machine-readable media including instructions which, when read by a machine, cause the machine to perform the operations of any one or more of the methodologies summarized above, or described elsewhere herein.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method, comprising:
receiving, at a first device, unencrypted data via a first channel;
causing, by the first device, generating a data entry form at a second device based on the received unencrypted data;
causing, by the first device, transmitting, from the second device, the generated data entry form to a third device via a second channel, the generated data entry to be displayed within a webpage on the third device;
causing, by the first device, intercepting and encrypting data entered into the generated data entry from by a user; and
receiving, by the first device, via the second channel the encrypted data.

2. The method of claim 1, wherein the first channel includes voice communication and the second channel includes digital communication.

3. The method of claim 1, further comprising generating and transmitting, by the first device, a one-time use confidence image, to the third device based on the received unencrypted data.

4. The method of claim 1, further comprising:
causing the second device to generate a single-use token in response to intercepting the data and transmitting the token to the third device;
completing a transaction between the third device and a fourth device based on the third device's receipt of the token.

5. The method of claim 1, further comprising prepopulating the data entry form with the received unencrypted data.

6. The method of claim 1, where in the unencrypted data includes non-regulated data and the encrypted data includes regulated data.

7. The method of claim 1, wherein the encrypted data includes browser data and third device data.

8. The method of claim 1, further comprising recording transaction velocity at the second device and transmitting the recorded transaction velocity to the third device.

9. The method of claim 1, wherein the generating a data entry form includes creating empty Document Object Model containers.

10. A computer-readable medium having stored thereon instructions to cause a computer to execute a method, the method comprising:
receiving, at a first device, unencrypted data via a first channel;
causing, by the first device, generating a data entry form at a second device based on the received unencrypted data;
causing, by the first device, transmitting, from the second device, the generated data entry form to a third device via a second channel, the generated data entry to be displayed within a webpage on the third device;
causing, by the first device, intercepting and encrypting data entered into the generated data entry from by a user; and
receiving, by the first device, via the second channel the encrypted data.

11. A system, comprising:
a processor; and
a memory storing instructions, that, when executed by the processor, causes the system to perform a method, the method comprising:
receiving, at a first device, unencrypted data via a first channel;
causing, by the first device, generating a data entry form at a second device based on the received unencrypted data;
causing, by the first device, transmitting, from the second device, the generated data entry form to a third device via a second channel, the generated data entry to be displayed within a webpage on the third device;
causing, by the first device, intercepting and encrypting data entered into the generated data entry from by a user; and
receiving, by the first device, via the second channel the encrypted data.

12. The system of claim 11, wherein the first channel includes voice communication and the second channel includes digital communication.

13. The system of claim 11, further comprising generating and transmitting, by the first device, a one-time use confidence image, to the third device based on the received unencrypted data.

14. The system of claim 11, further comprising:
causing the second device to generate a single-use token in response to intercepting the data and transmitting the token to the third device;
completing a transaction between the third device and a fourth device based on the third device's receipt of the token.

15. The system of claim 11, further comprising prepopulating the data entry form with the received unencrypted data.

16. The system of claim 11, where in the unencrypted data includes non-regulated data and the encrypted data includes regulated data.

17. The system of claim 11, wherein the encrypted data includes browser data and third device data.

18. The system of claim 11, further comprising recording transaction velocity at the second device and transmitting the recorded transaction velocity to the third device.

19. The system of claim 11, wherein the generating a data entry form includes creating empty Document Object Model containers.
